(19) United States
(12) Patent Application Publication
(10) Pub. No.: US 2006/0108934 A1
(43) Pub. Date: May 25, 2006

(54) Generating device for generating electricity by shaking

(75) Inventor: Ching-Tien Tsai, Changhua Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: HSINN INN ENTERPRISE CO., LTD., Changhua Hsien (TW)

(21) Appl. No.: 11/195,076

(22) Filed: Aug. 2, 2005

(30) Foreign Application Priority Data
Nov. 24, 2004 (TW) 093218860

(51) Int. Cl. H01J 7/24

(52) U.S. Cl. 315/111.41

(57) ABSTRACT

A generating device includes a tube, a coil mounted around the tube, and a permanent magnet movably mounted in the tube to pass through the coil. Thus, the permanent magnet is movable in the tube reciprocally by a shaking action to pass through the coil to cause variation of a magnetic field of the coil, so that the coil produces an electric current by variation of the magnetic field, thereby generating the electricity so as to supply an electric power to the light emitting diodes. In addition, the light emitting diodes are lighted by a shaking action without needing aid of an external power supply or a battery.

### BACKGROUND OF THE INVENTION

1. Field of the Invention

The present invention relates to a generating device, and more particularly to a generating device for generating electricity by shaking.

2. Description of the Related Art

A light emitter can light or blink to enhance its outer appearance. However, the electric power of the conventional light emitter is supplied by an external power supply or a battery, thereby wasting the natural resource, increasing the price, and easily-causing environmental pollution problems.

### SUMMARY OF THE INVENTION

In accordance with the present invention, there is provided a generating device, comprising a tube, a coil mounted around the tube, and a permanent magnet movably mounted in the tube to pass through the coil.

The primary objective of the present invention is to provide a generating device that converts a mechanical energy into an electrical energy in a shaking manner so as to generate an electric power.

Another objective of the present invention is to provide a generating device, wherein the permanent magnet is movable in the tube reciprocally by a shaking action to pass through the coil reciprocally to cause variation of a magnetic field of the coil, so that the coil produces an electric current by variation of the magnetic field, thereby generating the electricity so as to supply an electric power to the light emitting diodes.

A further objective of the present invention is to provide a generating device, wherein the light emitting diodes are lighted by a shaking action without needing aid of an external power supply or a battery, thereby saving the natural resource, decreasing the price, and enhancing the environmental protection effect.

A further objective of the present invention is to provide a generating device, wherein the generating device has a smaller volume, a lighter weight and a cheaper price, thereby satisfying the practical requirements of the customers.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a generating device in accordance with the preferred embodiment of the present invention;

FIG. 2 is a plan cross-sectional view of the generating device as shown in FIG. 1;

FIG. 3 is a circuit layout of the generating device as shown in FIG. 1; and

FIG. 4 is a schematic operational view of the generating device as shown in FIG. 2 in use.

### DETAILED DESCRIPTION OF THE INVENTION

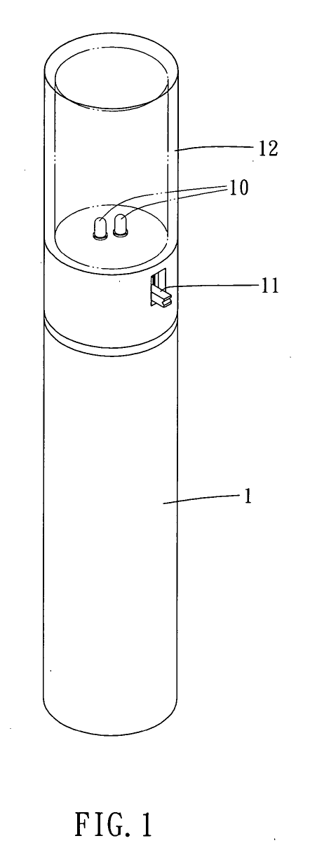

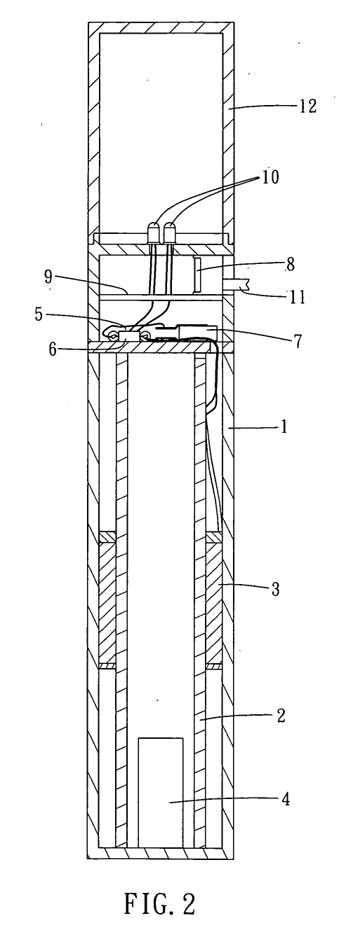

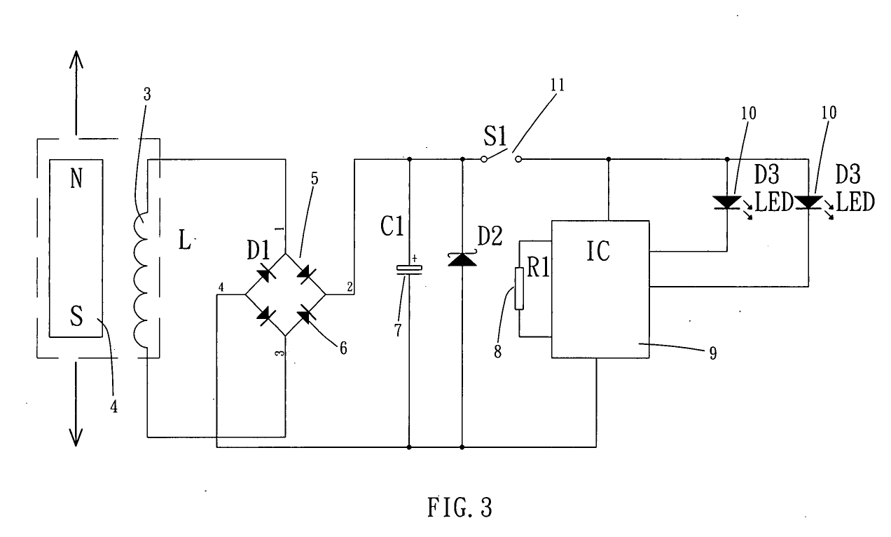

Referring to the drawings and initially to FIGS. 1-3, a generating device in accordance with the preferred embodiment of the present invention comprises a barrel 1, a tube 2 mounted in the barrel 1, a coil 3 mounted around the tube 2 and located in the barrel 1, a substantially cylindrical permanent magnet 4 movably mounted in the tube 2, and a rectifier 5 connected to the coil 3 by conducting wires.

The coil 3 is mounted around a peripheral wall of the tube 2 and located at a mediate portion of the tube 2. The permanent magnet 4 is movable in the tube 2 reciprocally to pass through the coil 3 reciprocally. The rectifier 5 consists four diodes 6. The rectifier 5 is mounted on an upper portion of the barrel 1 and connected to a capacitor 7, a resistor 8 and an integrated circuit 9 by conducting wires. The integrated circuit 9 is connected to a plurality of light emitting diodes 10 by conducting wires. The light emitting diodes 10 are mounted on the upper portion of the barrel 1. The integrated circuit 9 is connected to a switch 11 which is exposed outward from the barrel 1. A transparent shade 12 is mounted on the upper portion of the barrel 1, and the light emitting diodes 10 are mounted in the transparent shade 12.

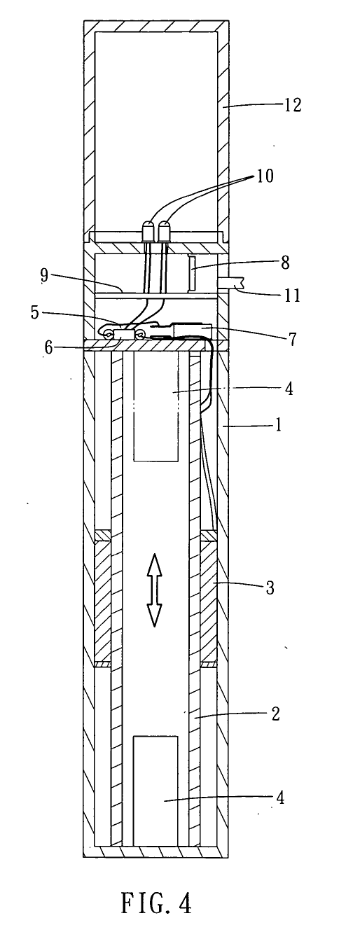

When in user, referring to FIGS. 1-4, after the switch 11 is turned on, a user's one hand can hold the barrel 1 to shake the barrel 1, so that the permanent magnet 4 is movable in the tube 2 reciprocally to pass through the coil 3. In such a manner, the permanent magnet 4 passes through the coil 3 reciprocally to cause variation of a magnetic field of the coil 3, so that the coil 3 produces an electric current by variation of the magnetic field, thereby generating electricity. Then, the electric current is rectified by the rectifier 5, filtered by the capacitor 7 and limited by the resistor 8. Then, the electric current passes through the integrated circuit 9 to form an impulse current which is transmitted to the light emitting diodes 10 so that the light emitting diodes 10 light or blink to produce different light emitting effects.

At this time, the capacitor 7 stores the electric current when the electric current passes through the capacitor 7, so that the capacitor 7 can discharge after the generating process is stopped due to stop of the shaking action, and the light emitting diodes 10 can light during a period of time after the shaking action is stopped.

In addition, the generating device is available for a present, an ornament, a toy, a hollow stick or the like.

Accordingly, the permanent magnet 4 is movable in the tube 2 reciprocally by a shaking action to pass through the coil 3 reciprocally to cause variation of a magnetic field of the coil 3, so that the coil 3 produces an electric current by variation of the magnetic field, thereby generating the electricity so as to supply an electric power to the light emitting diodes 10. In addition, the light emitting diodes 10 are lighted by a shaking action without needing aid of an external power supply or a battery, thereby saving the natural resource, decreasing the price, and enhancing the environmental protection effect. Further, the generating device has a smaller volume, a lighter weight and a cheaper price, thereby satisfying the practical requirements of the customers.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A generating device, comprising:
a tube;
a coil mounted around the tube;
a permanent magnet movably mounted in the tube to pass through the coil.

2. The generating device in accordance with claim 1, wherein the coil is mounted around a peripheral wall of the tube.

3. The generating device in accordance with claim 1, wherein the coil is located at a mediate portion of the tube.

4. The generating device in accordance with claim 1, wherein the permanent magnet has a substantially cylindrical shape.

5. The generating device in accordance with claim 1, wherein the permanent magnet is movable in the tube reciprocally to pass through the coil reciprocally.

6. The generating device in accordance with claim 1, wherein the tube is mounted in a barrel.

7. The generating device in accordance with claim 6, wherein the coil is located in the barrel.

8. The generating device in accordance with claim 1, further comprising a rectifier connected to the coil.

9. The generating device in accordance with claim 8, wherein the rectifier consists a plurality of diodes.

10. The generating device in accordance with claim 8, wherein the rectifier is connected to a capacitor, a resistor and an integrated circuit.

11. The generating device in accordance with claim 10, wherein the integrated circuit is connected to a plurality of light emitting diodes.

12. The generating device in accordance with claim 11, further comprising a barrel mounted around the tube, and the light emitting diodes are mounted on an upper portion of the barrel.

13. The generating device in accordance with claim 12, wherein the rectifier is mounted on the upper portion of the barrel

14. The generating device in accordance with claim 12, further comprising a transparent shade mounted on the upper portion of the barrel, and the light emitting diodes are mounted in the transparent shade.

15. The generating device in accordance with claim 12, wherein the integrated circuit is connected to a switch which is exposed outward from the barrel.

16. The generating device in accordance with claim 1, wherein the permanent magnet is movable in the tube by a shaking action.
